(19) United States
(12) Patent Application Publication
(10) Pub. No.: US 2005/0114889 A1
(43) Pub. Date: May 26, 2005

(54) Method for searching television channels

(76) Inventors: Bao-Kim Liu, Jungli City (TW); Jung-Yi Yang, Jungli City (TW); Chun-Hao Lee, Jungli City (TW); Chien-Ken Chang, Jungli City (TW)

Correspondence Address: J C PATENTS, INC., 4 VENTURE, SUITE 250, IRVINE, CA, 92618, US

(21) Appl. No.: 10/977,126

(22) Filed: Oct. 29, 2004

(30) Foreign Application Priority Data
Oct. 29, 2003 (TW) 92130003

(51) Int. Cl. H04N 5/44; H04N 5/445; G06F 3/00; G06F 13/00

(52) U.S. Cl. 725/53; 348/734

(57) ABSTRACT

A method for searching television channel is provided. An initial frequency and a frequency search interval are set. Thereafter, using the initial frequency as the starting point, television signals are scanned to find any television channel within a designated frequency bandwidth. The channel ID is resolved from the channel frequency based on a specific broadcasting system on each detecting of the channel signals. The channel frequency and frequency ID of any television channel thus found are also stored. In this invention, the television channel is searched by frequency instead of a channel table as in a conventional method.

### CROSS-REFERENCE TO RELATED APPLICATION

This application claims the priority benefit of Taiwan application serial no. 92130003, filed Oct. 29, 2003.

### BACKGROUND OF THE INVENTION

1. Field of the Invention

The present invention relates to a method for searching channels. More specifically, the present invention relates to a method for searching television channels.

2. Description of the Related Art

At present, although arrangement of the television channels are ruled by the “Consultative Committee for International Radio” (CCIR), the actual frequency often deviates from the designated standard channel frequency due to geographical limitations and the quality of transmission by the broadcasting station. Therefore, the quality of television reception is considerably affected, or one cannot tune in to watch the programs broadcast by a specific station because the channel cannot be effectively located. In China, for example, the quality of television broadcast signal varies from place to place due to the range of areas and different topography the signals have to cover. Furthermore, too many neighboring countries with different broadcasting systems make the boundaries almost chaotic. Furthermore, for the NTSC system in United States, in addition to the on-air and the cable transmission systems, the cable transmission system is further divided into various sub-systems including STD (Standard), HRC (Harmonic Related Carrier) and IRC (Incremental Related Carrier). Users are always confused by these systems, therefore users frequently operate the frequency to a wrong TV broadcasting system thus the appropriate television signals can not be received.

FIG. 3A is a flowchart showing a conventional method of searching for the television channels. As shown in FIG. 3A, the conventional searching method uses the standard channel table as a reference in the search. The searching method will determine if there is a TV signal received when system tunes at a specific frequency standard in the standard channel table. If the broadcasting television signal deviates from those specific frequencies on the standard frequency table, the searching system will miss the television signal of the channel due to misjudge or receive the television signal of serious attenuation of the channel. Even if a channel is successfully detected, but the frequency shift away from the standard frequency will lead to serious attenuation of the received signals.

FIG. 3B is a diagram showing a conventional method of searching out broadcasting television channels. As shown in FIG. 3B, in the prior art searching method for searching TV channels. Firstly the channel 6 (at 85.25 MHz) is searched, next, the searching method will jump to the frequency 169.25 MHz to search channel 7 (in step S320). From channel 7 to channel 13 (at 211.25 MHz) is a sequential search, there the searching method will jump again to the frequency 115.25 MHz to search channel 14 (in step S340). In fact, similar frequency jumps also occurs during the following channel searches, namely, CH22˜CH23, CH65˜CH66, CH94˜CH95 and CH99˜CH100.

The TV broadcasting systems in United States, aside from National Television System Committee (NTSC) TV system, the cable broadcasting system further comprises Standard (STD), Harmonic Related Carrier (HRC) and Incremental Related Carrier (IRC) standards. FIG. 2A is a table listing out some of the conventional CATV channel frequencies. In FIG. 2A, the STD, HRC and IRC systems have slightly differences in the frequency channels. However, for the IRC system, aside from channel 5 and channel 6, which differ from the STD system, each frequency of all other channels is identical to the STD system's. FIG. 2B is a schematic diagram showing the difference in channel frequencies between the conventional HRC and STD/IRC systems. As shown in FIG. 2B, in addition to the channels 5 and 6, the HRC system has channel frequencies different from the STD/IRC systems.

Thus, before the search system can search out a right channel, a user has to select the correct television broadcasting system. If the user is not familiar with television broadcasting system and sets the system incorrectly, there will be a problem for the channel receiving.

### SUMMARY OF THE INVENTION

Accordingly, at least one objective of the present invention is to provide a method for searching television broadcasting signals such that the correct television signal is always obtained whatever the type of signals, systems or transmission modes.

Further, a second aspect of the invention provides the method for assigning channel IDs in a video system to searched channel frequencies to be compatible with the real channel ID in the existing broadcasting systems.

To achieve these and other advantages and in accordance with the purposes of the invention, as embodied and broadly described herein, the invention provides a method for searching television channels. An initial scanning frequency and a frequency search interval are set. If the initial scanning frequency is not the highest or the lowest frequency within the search band, the search system will scan sequentially and incrementally from the initial scanning frequency to the highest frequency or from the initial scanning frequency to the lowest frequency until signals within the entire television frequency band are searched. To speed up the search, the unspecified antenna TV or the forbidden frequency ranges are skipped. Thereafter, each searched channel frequency is matched with the channel frequency defined in the standard frequency table to ascertain its existence and find the channel's central frequency. Finally, the central channel frequency is recorded sequentially or according to the sequence and distribution of the standard channel. The recorded central channel frequency can be used for selecting a proper channel later on.

In this invention, the television signal is searched based on a fix interval increasing frequency search method instead of the standard channel table used in a conventional method. Instead of based on any table or standard, a direct frequency search method is used so that all frequencies in all television broadcasting channels within a bandwidth can be found. After storing all the searched channels in a frequency table, the table can be used for television signal reception reference. Hence, the users no longer have to be burdened with setting the system before check what the broadcasting television channels is available.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a flowchart showing the steps for searching television channels according to one preferred embodiment of this invention.

FIG. 1B is a schematic diagram showing the distribution of channels within a frequency band.

FIG. 2A is a table listing out some of the conventional CATV channel frequencies.

FIG. 2B is a schematic diagram showing the difference in channel frequencies between the conventional HRC and STD/IRC systems.

FIG. 2C is a table showing the frequency groups in the CATV broadcasting system.

FIG. 2D is a table showing the frequency range and corresponding channel ID in cable HRC and STD/IRC broadcasting systems.

FIG. 2E is a table showing the frequency range and corresponding channel ID in NTSC TV broadcasting systems.

FIG. 2F is a flowchart showing the steps for assigning channel ID to searched television channel according to one preferred embodiment of this invention.

FIG. 3A is a flowchart showing a conventional method of searching for the television channels.

FIG. 3B is a diagram showing a conventional method of searching out broadcasting television channels.

FIG. 4 is a block diagram showing the hardware components inside a conventional television system.

FIG. 5A is a schematic diagram showing the circular search sequence for upward frequencies searching.

FIG. 5B is a schematic diagram showing the circular search sequence for downward frequencies searching.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

One major aspect of this invention is that searching TV channels based on channel frequencies. In other words, television channels are searched out one by one through an incremental increase in frequency. Therefore, after scanning the entire frequency band, all the channels within the band can be sequentially and accurately scanned and determined. The embodiment of this invention is explained below using this concept and drawings. Note that a conventional channel table is not required in this invention. That means, the searching method according to this invention is not confined to any specific broadcasting systems.

At present, there are the PAL, NTSC and other cable broadcasting system for television broadcasting systems. When a television is set to receive one system, then the other system will not be received. Even if a television can be set to receive two systems, the setting will be very complicated. Since the search method of the present invention searches the broadcasting TV signal by incrementally increasing frequency within a frequency band, the search used the channel frequency table of various systems becomes unnecessary. Therefore, the method of this invention can be applied to the PAL and the NTSC systems or any other type of cable broadcasting television systems.

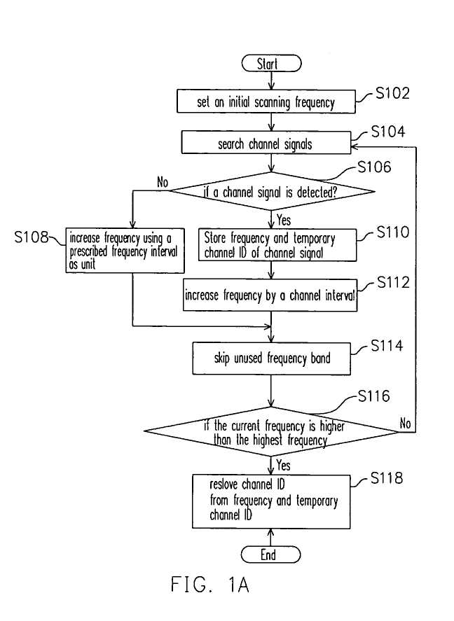

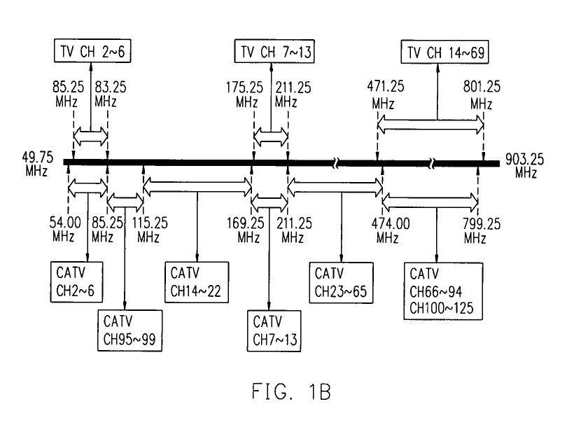

FIG. 1A is a flowchart showing the steps for searching broadcasting television channels according to one embodiment of this invention. FIG. 1B is a schematic diagram showing the distribution of channels within a frequency band. As shown in FIGS. 1A and 1B, the system set the searching frequency to an initial frequency and set a frequency search interval (in step S102). The initial frequency is a frequency starting point between the highest frequency and the lowest frequency within a frequency band. The lowest frequency is an end point in the frequency such that channel cannot be found if a frequency lower than the lowest frequency is searched. The highest frequency is an end point in the frequency search because no channel can be found for a searching frequency higher than that. In this embodiment, the initial frequency can be set to 49.75 MHz and the highest frequency can be set to 903.25 MHz. This setting may vary according to the actual specification of the frequency band.

In step S104, using the preset initial frequency as a starting point and the preset frequency interval as an increment unit, the channel signals within the frequency band are to be searched. In general, the frequency interval has no specific limitations. The smallest value for the frequency interval can be set in a way that all the broadcasting signal channels of a specific television system can be detected. The typical setting of the frequency interval is 62.5 KHz or 50 KHz. For example, as shown in FIG. 1B, after setting the initial frequency to 49.75 MHz and the highest searching frequency to 903.25 MHz, the aforementioned frequency interval is used as a unit to be added to the searching frequency from the starting point of 49.75 MHz. Based on the current searching frequency, in order to quickly and accurately locate the actual frequency of the channel signal around the current searching frequency, a well-known AFT signal from tuner may be used in this step (will be further described later).

In step S1106, the system determines if any channel signal is detected, for example, the detection of any synchronization signal of video signal. If the channel signal has not been found, step S108 is carried out to increase the frequency by the frequency interval and start to search the next frequency. Conversely, if a synchronization signal is found in step S106 at a specific frequency, that is, a channel is found, step S110 is carried out storing the frequency as well as its temporary corresponding channel ID (will be further described later) in memory. In general, the frequency and corresponding channel ID are stored inside a memory device of the system, such as an electrically erasable and programmable read-only memory (EEPROM).

In step S112, the system uses a channel interval to increase the frequency so as to carry out a channel detection. Aside from using the channel width as an upper limit of the frequency interval, there are no other special limitations. Using a channel width of 6 MHz as an example, the frequency interval can be 4 MHz or 3 MHz. In practice, the value should be adjusted according to the actual operating conditions. Once a first channel signal is found, the channel width can be used as the incremental frequency interval for finding other channels. Hence, in step S112, the search is carried out with frequency increasing cumulatively at the channel interval.

In step S114, the system will skip over unused frequency bands to save time. The unused frequency bands include the redundant frequency band or a plurality of fixed frequencies. The unused frequency bands are usually different for each country for certain purposes or some special reasons. For example, a few frequency bands are not open to the public in Taiwan due to military security. Furthermore, a few frequency bands may overlap with air traffic control communication and hence cannot be used by the public. Because each nation may block a few frequency bands to the public, these unused frequency bands can be programmed into the system before initiating the channel search. In this way, these forbidden or unused frequency bands can be skipped over to save some search time.

In step S116, the current searched frequency is compared with the highest searching frequency to determine if the current searched frequency is higher than the highest searching frequency. If the current searched frequency is still below the highest searching frequency, step S104 is carried out next. On the contrary, if the current searched frequency has already exceeded the highest searching frequency, a program for resolving the frequency within the channel signals according to the channel codes is initiated.

As shown in FIG. 1B, the search begins from the initial frequency and moves up in frequency to find signals so that all the central frequencies of signals within the frequency band, for example, the signals within the frequency band 49.75 Mhz to 54.75 MHz are found. It does not really matter if the search is based on the STD, HRC or IRC system.

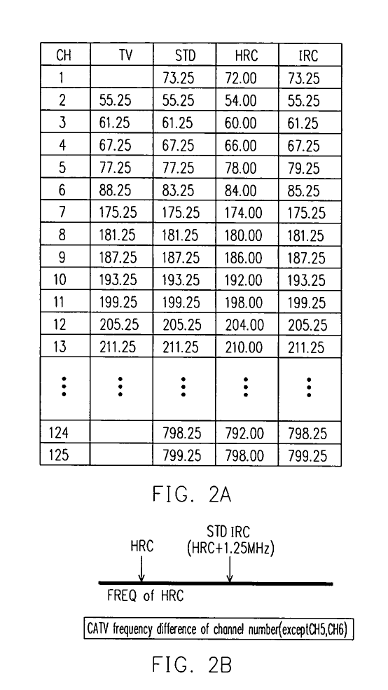

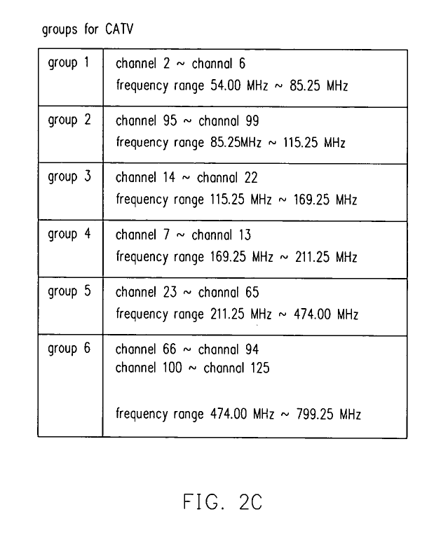

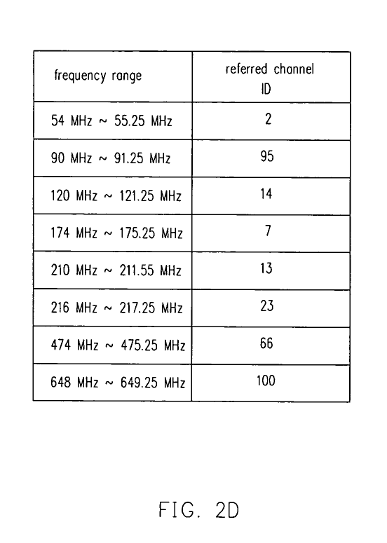

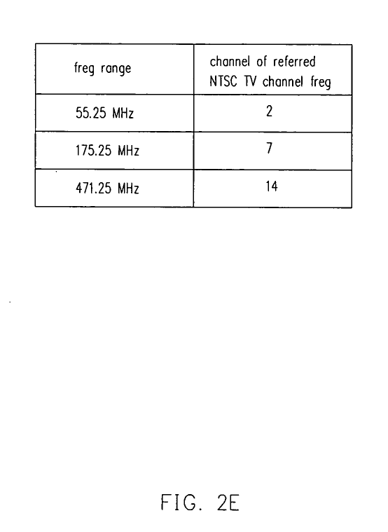

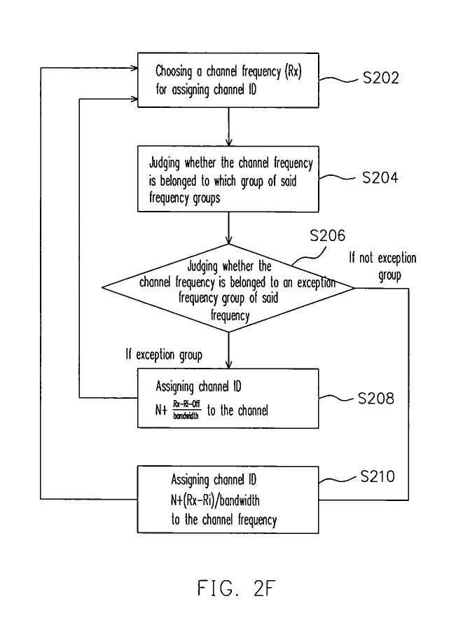

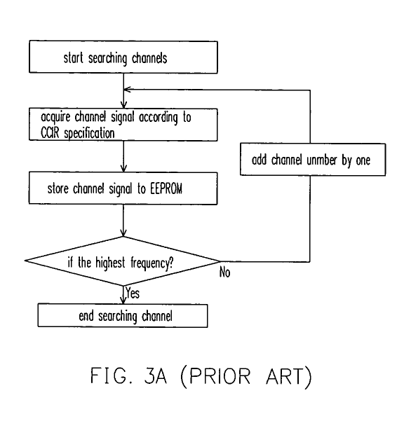

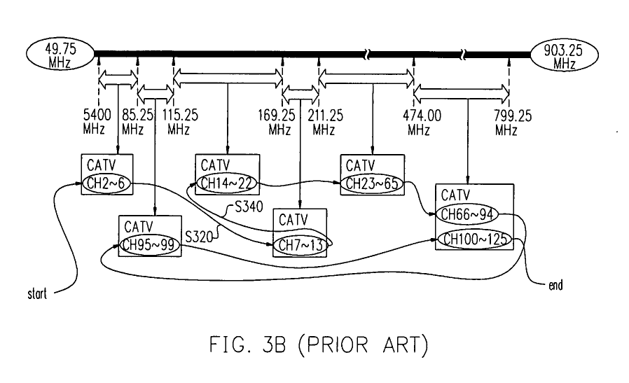

As shown in FIG. 2F, FIG. 2F is a flowchart showing the steps for assigning channel ID to searched television channel according to one preferred embodiment of this invention. After search out the available channels, we assign the available channels with a temporary channel ID. But the temporary channel ID doesn't corresponding to the real channel ID in the standard frequency channel table. The method for assigning channel ID in a video system to searched channel frequencies to be compatible with the real channel ID in the existing broadcasting systems.

Although the central frequencies may differ somewhat in value, only one channel signal exists in this interval. Therefore, the channel signal within this frequency band corresponds to “channel 2” and then defined as “channel 2.” Thereafter, with 5 MHz as the incremental frequency interval, the signal within the next frequency band is searched. In other words, the signal frequency within the frequency band 54.75 MHz to 59.75 MHz is searched. After detecting channel 6 within the frequency band 84 MHz to 85.25 MHz, all the signals within the frequency band 54 MHz to 85.25 MHz are searched. In the conventional method, the next channel, that is, channel 7 is the target after channel 6. However, to find the channel signals for channels 7˜13, the searching of the frequency has to jump to a frequency band between 169.25 MHz to 211.25 MHz. In this invention, the search continues on within the frequency band 85.25 MHz to 115.25 MHz, the range for channel signals belonging to channel 95 to 99. This process is repeated until the highest frequency is reached. In other words, the frequency search stops only when the highest preset frequency 903.25 MHz is reached.

According to one preferred embodiment of this invention, all the signal frequencies can be mapped to a ‘standard frequency table’ so that appropriate channel IDs are found. After finding all the signal frequencies between the highest frequency and the lower frequency and mapping to a standard frequency table, signal reception may begin without any due regard to the difference in frequency between the STD, the HRC or the IRC system.

Please refer to FIG. 2C, FIG. 2D and FIG. 2E. FIG. 2C is a table showing the frequency groups in the CATV broadcasting system.

FIG. 2E is a table showing the frequency range and corresponding channel ID in NTSC TV broadcasting systems. It is noted that the searched broadcasting system comprises different frequency groups and each group having a referred channel frequency (Ri) with a corresponding channel ID (N), wherein frequency groups comprise at least one exception frequency group with a offset bandwidth (Off). Firstly, choosing a channel frequency (Rx) for assigning channel ID (in step S202). Then judging whether the channel frequency is belonged to which frequency group of said frequency groups (in step S204). Please refer to FIG. 1B, FIG. 2A and FIG. 2C, in STD cable broadcasting system there are six frequency groups, the group 1 is a exception frequency group while other frequency groups are normal frequency groups. The range of channel 4 to channel 5 is 10 MHz. So the offset bandwidth (Off) is 4 (10−6) MHz.

And judging whether the channel frequency is belonged to a exception frequency group of said frequency groups (in step S206). If the channel frequency is in the exception group, then assigning channel ID [N+(Rx−Ri−Off)/bandwidth] to the channel frequency (in step S208). And if the channel frequency is not in the exception group, then assigns channel ID [N+(Rx−Ri)/bandwidth] to the channel frequency (in step S210).

For example, if we have two searched frequency 83.25 MHz and 475.25 MHz in STD cable broadcasting system. Because 83.25 MHz is in frequency group 1, so we must subtract 4 MHz (Off) first, then the frequency is 79.25 MHz. And find the referred channel frequency (Ri), in frequency group 1 it's channel 2 (55.25 MHz). So the frequency range is 79.25 MHz-55.25 MHz. And in the STD broadcasting system, the bandwidth is 6 MHz. Finally, we get the channel ID is 6. Because 24 MHz divides 6 MHz is 4 and 4 is added to 2 (channel 2) equals 6.

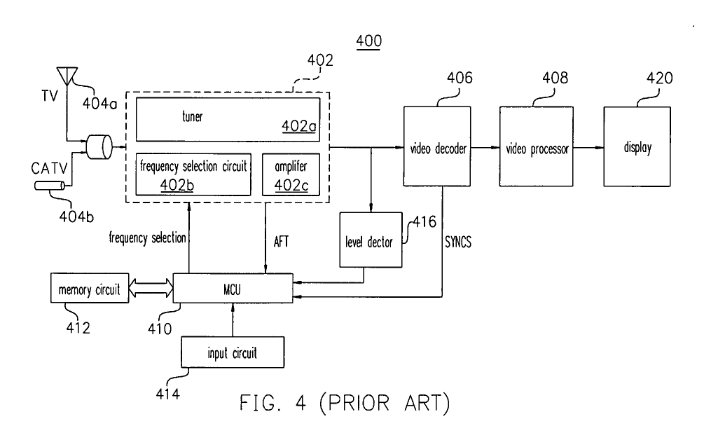

FIG. 4 is a block diagram showing the hardware components inside a conventional television system. The aforementioned method according to this embodiment can be implemented using a conventional hardware system as shown in FIG. 4. All that is required is a minor adjustment to the program within the micro-control unit (MCU) of the system. Thus, the method of this invention incurs no extra hardware cost and is easy to set.

As shown in FIG. 4, the hardware structure of a television system 400 mainly comprises a tuning module 402, a television antenna 404a, a cable television (CATV) input terminal 404b, a video decoder 406, a video processor circuit 408, a micro-control unit (MCU) 410, a memory circuit 412, an input circuit 414, a level detector 416 and a display device 420.

In the following, only the relevant hardware components are described because all other components have the conventional usage. The television system 400 receives television signals through the antenna 404a or the cable television terminal 404b. After passing through the tuning module 402, the received signals are tuned and transmitted to the video decoder 406 and the level detector 416. The video decoder 406 decodes the tuned signals and outputs synchronization signals (Syncs) to the micro-control unit 410. In addition, the tuned signal is also sent to the level detector 416. The level detector 416 determines if the tuned signal reaches a prescribed level and outputs the results to the micro-control unit 410. If reaching the prescribed level, the tuned signal may correspond to a channel. In the meantime, if the video decoder 406 also sends synchronization signals (Syncs) to the micro-control unit 410, the tuned signal is judged to be a channel signal. Besides, for fast and accurately located the frequency of the tuned channel, a well-known AFT signal output from the tuning module 402 is optionally provided to the micro-control unit 410 for determination of what is the direction and how much the frequency deviation from the central frequency of the tuned channel signal. According to the frequency of the tuned signal, the micro-control unit 410 sets the channel and then transfers the resulting setting to the memory circuit 412. According to the embodiment of this invention, all the signal frequencies are found through a sequential search from the lowest frequency to the highest frequency of a frequency band by setting up in a program within the micro-control unit 410.

After setting up all the channels, a user can select a desired channel via the input circuit 414, such as a remote controller, etc. A signal for selecting a specific channel is sent via the input circuit 414 to the micro-control unit 410. The required frequency and channel is retrieved from the memory circuit 412 and then transmitted to the frequency selection circuit 402b of the tuning module 402. After the tuner 402a has performed the required tuning with the incoming frequency, the signal is sent to the video decoder 406. The video decoder 406 decodes the signals and passes the decoded signals to the video processor circuit 408 for further processing. Finally, the video signals are sent to the display device 210, so as to produce an image on the display device 210 to the user.

In summary, advantages of this invention includes the followings. There is no need to use the standard channel table for searching the television channel signals. The optimum signals of all available television channel signals in a frequency band can be accurately located and found. Hence, at places where channel tables are lacking or the channels are chaotic, all the channels can be effectively searched without using the channel table, such as the PAL/DK system in China.

In addition, according to this invention, the frequency search is based not according to any channel table format. In fact, all the available frequencies of each channel table are found even if there are several types of channel tables co-existing together. Without the constraints of channel tables, all the available channels can be found regardless of whether the signals are sent by air or cable transmission or whether the cable system uses the STD, HRD or IRC system. Furthermore, the television frequencies found by the method can be inferred back to the correct station (such as the NTSC system in USA and Taiwan or the PAL system in Europe).

The search is unrestricted by any difference between several television systems within a local area and frequency deviation problem is also resolved. Because frequency itself serves as the base in the search, the correct channel signals are always found even if an incorrect system channel table is selected.

The searching process is no longer limited by the signal strength. When the reception discovers some abnormality, signal deviation or change, channel search can begin anew. The newly acquired information is then transferred to a new channel table so that the channel with weak or frequency deviated signals can be re-adjusted for a better reception.

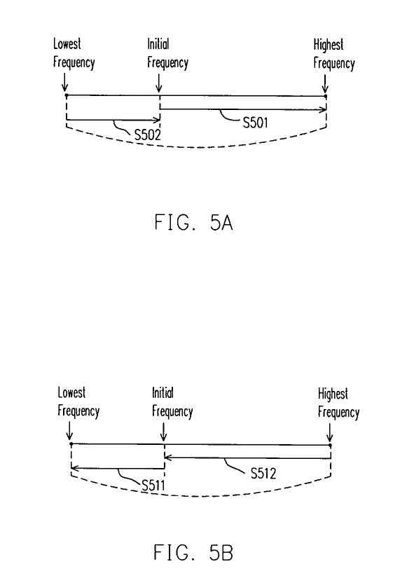

Although the channel searching scheme of the aforementioned embodiment of the present invention is in the manner of searching out channels one by one through an incremental increase in frequency, an alternative embodiment of the present invention may selectively search out the TV channels one by one through a decreasingly decrease in frequency from the initial frequency. With reference to FIG. 1A, the whole process is almost the same except the step S108, S112 were appropriately modified as “decrease frequency” instead of “increase frequency” and step S116 were appropriately modified as checking “if the current frequency is lower than the lowest frequency” instead of “if the current frequency is higher than the highest frequency”. On the other hands, the frequency search scheme may be performed in circular manner with reference to FIG. 5A and FIG. 5B. Firstly, refer to FIG. 5A, if the searching direction is upward, the searching process starts from initial frequency toward the highest frequency as S501 and then from the lowest frequency to the initial frequency as S502. Conversely, refer to FIG. 5B, if the searching direction is downward, the searching process starts from initial frequency toward the lowest frequency as S511 and then from the highest frequency to the initial frequency as S512.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for searching a plurality of television channels within a frequency band, comprising the steps of:
setting an initial frequency;
setting a frequency interval;
searching in sequence for all the channel signals within the frequency band set between a lowest frequency and a highest frequency by starting from the initial frequency and using the frequency interval as a search unit;
resolving channel IDs corresponding to the searched channel frequencies based on a specific broadcasting system; and
storing said searched channel frequency and said corresponding channel ID inside a memory unit after finding each channel signal within the frequency band.

2. The method of claim 1, wherein the frequency interval has an upper limit based on the frequency bandwidth of each channel.

3. The method of claim 1, wherein the search and detection of channel signals is based on a synchronization signal.

4. The method of claim 1, wherein the method is suitable for searching television channels in a PAL system and an NTSC system.

5. The method of claim 1, wherein the search is performed in circulating when the initial frequency is not the highest frequency or the lowest frequency.

6. A method for searching a plurality of television channels within a frequency band having at least an unused frequency band therein, comprising the steps of:
setting an initial frequency and a frequency interval; and
searching in sequence for all the channel signals within the frequency band set between a lowest frequency and a highest frequency by starting from the initial frequency and using the frequency interval as a search unit until all frequency signals are searched, and
resolving the channel ID corresponding to the searched channel frequency based on a specific broadcasting system on finding each channel signal within the frequency band;
wherein when a channel signal is searched, a frequency and a channel ID corresponding to the searched channel signal are stored, and when reaching the unused frequency, the unused frequency is skipped to search other channel signals, until all frequency signals are searched.

7. The method of claim 6, wherein the search is performed in circulating when the initial frequency is not the highest frequency or the lowest frequency.

8. The method of claim 6, wherein the frequency interval has an upper limit based on the frequency bandwidth of each channel.

9. The method of claim 6, wherein the search and detection of channel signals is based on a synchronization signal.

10. The method of claim 6, wherein the unused frequency band comprises a redundant frequency band.

11. The method of claim 6, wherein the unused frequency band comprises a fixed frequency.

12. A method for searching a plurality of television channels within a frequency band, comprising the steps of:
setting an initial frequency;
scanning for any channel signals between a highest frequency and a lowest frequency;
determining if a channel is detected, wherein if the channel is detected, resolving the channel ID from the detected channel frequency based on a specific broadcasting system and storing the frequency and corresponding channel ID in a memory unit;
determining if an unused frequency band is detected, and if detected, the unused frequency band is skipped; and
determining if the entire frequency band is scanned, if not, a frequency interval is added or subtracted to the frequency in accordance with the scanning direction and the search for the next channel signal is continued, however, if the entire frequency band is scanned, the search for television channels is terminated.

13. The method of claim 12, wherein the scanning is performed in circulating when the initial frequency is not the highest frequency or the lowest frequency.

14. The method of claim 12, wherein the frequency interval has an upper limit based on the frequency bandwidth of each channel.

15. The method of claim 12, wherein the detecting of channel signals is based on a synchronization signal.

16. The method of claim 12, wherein the unused frequency band comprises a redundant frequency band.

17. The method of claim 12, wherein the unused frequency band comprises a fixed frequency.

18. A method for assigning channel ID in a video system to searched channel frequencies to be compatible with existing broadcasting systems, said broadcasting systems comprising frequency groups and each group having a referred channel frequency (Ri) with a corresponding channel ID (N), wherein frequency groups comprise at least one exception frequency group with a offset bandwidth (Off), the method comprising:
choosing a channel frequency (Rx) for assigning channel ID;
judging whether the channel frequency is belonged to which frequency group of said frequency groups;
judging whether the channel frequency is belonged to a exception frequency group of said frequency groups;
assigning channel ID [N+(Rx−Ri−Off)/bandwidth] to the channel frequency, if the channel frequency is in the exception group;
assigning channel ID [N+(Rx−Ri)/bandwidth] to the channel frequency if the channel frequency is not in the exception group.
